(19) United States
(12) Patent Application Publication
(10) Pub. No.: US 2025/0373057 A1
(43) Pub. Date: Dec. 4, 2025

(54) POWER SUPPLY AND PROGRAM FOR POWER SUPPLY

(71) Applicant: Murata Manufacturing Co., Ltd., Nagaokakyo-shi (JP)

(72) Inventor: Kenta FUJII, Nagaokakyo-shi (JP)

(73) Assignee: Murata Manufacturing Co., Ltd., Nagaokakyo-shi (JP)

(21) Appl. No.: 19/206,142

(22) Filed: May 13, 2025

(30) Foreign Application Priority Data
Jun. 3, 2024 (JP) 2024-090122

(51) Int. Cl. H02J 7/00

(52) U.S. Cl. CPC H02J 7/00714; H02J 7/00308; H02J 7/0047; H02J 2207/20

(57) ABSTRACT

A power supply includes a pair of output terminals, a high-potential power line, a battery, a switch located on the high-potential power line, a power converter circuit located on the high-potential power line, a voltage detector, a current detector, and a controller. The controller turns the switch off when a magnitude of a voltage detected by the voltage detector is equal to or smaller than a magnitude of a predetermined first voltage threshold and a magnitude of a current detected by the current detector is equal to or larger than a magnitude of a predetermined first current threshold.

### CROSS-REFERENCE TO RELATED APPLICATION

The present application claims priority to Japanese application number 2024-090122 filed in the Japanese Patent Office on Jun. 3, 2024, the entire contents of which are incorporated herein by reference.

### BACKGROUND

### 1. Field

The present disclosure relates to a power supply and a program for the power supply.

### 2. Description of the Related Art

A battery protection circuit disclosed in Japanese Unexamined Patent Application Publication No. 2003-282153 includes a control circuit and a field-effect transistor (FET) switch. The FET switch is disposed between a negative terminal of a battery and a ground output. The control circuit is configured to control turning the FET switch on or off. The control circuit is configured to detect an overvoltage condition for the battery based on a comparison with a reference voltage. The control circuit turns the FET switch off upon detecting the overvoltage condition.

In the battery protection circuit disclosed in Japanese Unexamined Patent Application Publication No. 2003-282153, the control circuit may erroneously detect an overvoltage condition in response to a momentary fluctuation in the voltage between battery terminals due to noise or other causes.

### SUMMARY

To address the above and other issues, the present disclosure provides a power supply including: a pair of output terminals; a power line connected to the output terminals; a battery capable of outputting power from the output terminals via the power line; a switch located on the power line; a power converter circuit located on the power line and capable of converting an input voltage and outputting a converted voltage; a voltage detector configured to detect a voltage that is output from the power converter circuit; a current detector configured to detect a current between the power converter circuit and the output terminals; and a controller capable of turning the switch on or off. The controller turns the switch off when a magnitude of the voltage detected by the voltage detector is equal to or smaller than a magnitude of a predetermined voltage threshold and a magnitude of the current detected by the current detector is equal to or larger than a magnitude of a predetermined current threshold.

The present disclosure also provides a program to be applied to a power supply, the power supply including a pair of output terminals; a power line connected to the output terminals; a battery capable of outputting power from the output terminals via the power line; a switch located on the power line; a power converter circuit located on the power line and capable of converting an input voltage and outputting a converted voltage; a voltage detector configured to detect a voltage that is output from the power converter circuit; a current detector configured to detect a current between the power converter circuit and the output terminals; and a controller capable of turning the switch on or off. The program includes instructions for causing the controller to turn the switch off when a magnitude of the voltage detected by the voltage detector is equal to or smaller than a magnitude of a predetermined voltage threshold and a magnitude of the current detected by the current detector is equal to or larger than a magnitude of a predetermined current threshold.

The present disclosure can reduce the possibility of the control circuit erroneously detecting an overvoltage condition.

### BRIEF DESCRIPTION OF THE DRAWINGS

FIG. 1 is a circuit diagram of a power supply;

FIG. 2 is a diagram illustrating a change in voltage and a change in current in a first control; and

FIG. 3 is a diagram illustrating a change in voltage and a change in current in a second control.

### DETAILED DESCRIPTION

### Embodiment of Power Supply and Program for Power Supply

An embodiment of a power supply and a program for the power supply will be described below. It should be noted that the drawings are schematic diagrams for ease of understanding, and components may be enlarged or omitted. Thus, a dimensional ratio of components may differ from the actual one.

### Overall Configuration

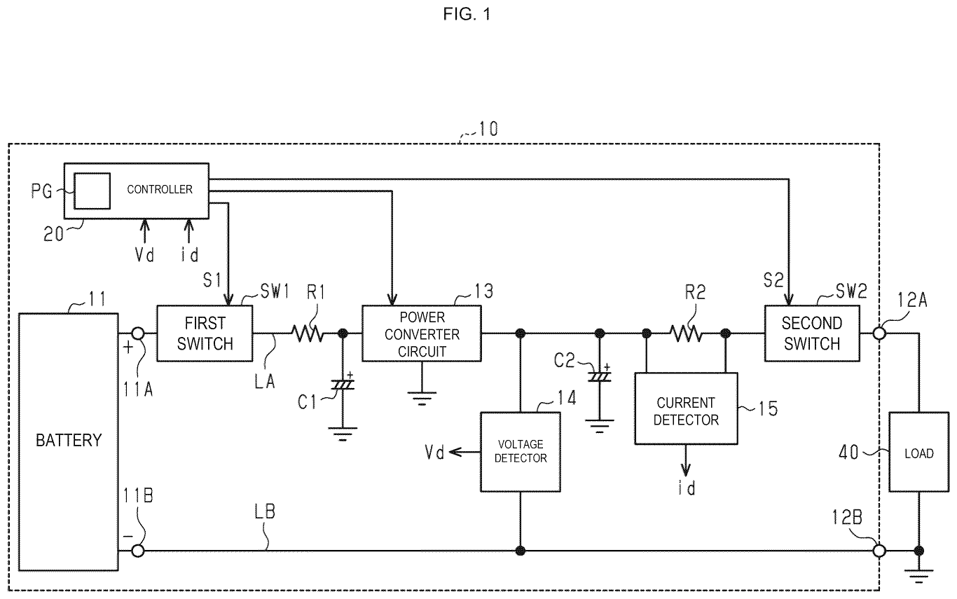

As illustrated in FIG. 1, a power supply 10 includes a battery 11, a high-potential power line LA, a low-potential power line LB, a high-potential output terminal 12A, a low-potential output terminal 12B, and a power converter circuit 13.

The battery 11 is a secondary battery, such as a lithium-ion battery, that is capable of being charged and discharged. The battery 11 includes a positive terminal 11A and a negative terminal 11B. The battery 11 is capable of supplying direct-current power to a load 40 connected between the high-potential output terminal 12A and the low-potential output terminal 12B. The high-potential output terminal 12A and the low-potential output terminal 12B may be connected to a power source, such as another power supply or a power system, connected in parallel with the load 40. In such a case, the battery 11 can receive direct-current power from a power source connected between the high-potential output terminal 12A and the low-potential output terminal 12B.

The high-potential power line LA is a power line that connects the positive terminal 11A of the battery 11 and the high-potential output terminal 12A. That is, a first end of the high-potential power line LA is connected to the positive terminal 11A of the battery 11. A second end of the high-potential power line LA is connected to the high-potential output terminal 12A. The high-potential output terminal 12A may be connected to the load 40.

The low-potential power line LB is a power line that connects the negative terminal 11B of the battery 11 and the low-potential output terminal 12B. That is, a first end of the low-potential power line LB is connected to the negative terminal 11B of the battery 11. A second end of the low-potential power line LB is connected to the low-potential output terminal 12B. The low-potential output terminal 12B may be connected to the load 40. The low-potential output terminal 12B is at the ground potential. The load 40 operates on a direct-current voltage from the power supply 10. Examples of the load 40 include a server and a storage in a data center.

The power converter circuit 13 is located on the high-potential power line LA. That is, an input terminal on the high potential side of the power converter circuit 13 is connected to the positive terminal 11A of the battery 11. An output terminal on the high potential side of the power converter circuit 13 is connected to the high-potential output terminal 12A.

The power converter circuit 13 according to the present embodiment is a bidirectional DC-DC converter. Thus, the power converter circuit 13 includes an inductor and a metal oxide semiconductor field-effect transistor (MOSFET.

The power converter circuit 13 can switch between a discharging state and a charging state under the control by a controller 20, which will be described later. In the discharging state, the load 40 is connected between the high-potential output terminal 12A and the low-potential output terminal 12B, and electric power stored in the battery 11 is discharged to the load 40. In the discharging state, the power converter circuit 13 converts a voltage that is input from the battery 11 into a predetermined voltage, which is output to the load 40. In the charging state, a power source is connected between the high-potential output terminal 12A and the low-potential output terminal 12B, and the battery 11 is charged from the power source. In the charging state, the power converter circuit 13 converts a voltage that is input from the power source into a predetermined voltage, which is output to the battery 11.

The power supply 10 includes a first resistor R1, a first capacitor C1, a second resistor R2, and a second capacitor C2.

The first resistor R1 is located on the high-potential power line LA. A first end of the first resistor R1 is connected to the positive terminal 11A of the battery 11. A second end of the first resistor R1 is connected to the input terminal of the power converter circuit 13. A first end of the first capacitor C1 is connected to the second end of the first resistor R1 and the input terminal of the power converter circuit 13. A second end of the first capacitor C1 is connected to the frame ground.

The second resistor R2 is located on the high-potential power line LA. A first end of the second resistor R2 is connected to the output terminal of the power converter circuit 13. A second end of the second resistor R2 is connected to the high-potential output terminal 12A. A first end of the second capacitor C2 is connected to the first end of the second resistor R2 and the output terminal of the power converter circuit 13. A second end of the second capacitor C2 is connected to the frame ground.

The power supply 10 includes a first switch SW1 and a second switch SW2. The first switch SW1 and the second switch SW2 are both located on the high-potential power line LA and can be turned on or off.

The first switch SW1 is located between the battery 11 and the power converter circuit 13 on the high-potential power line LA. More specifically, a first end of the first switch SW1 is connected to the positive terminal 11A of the battery 11. A second end of the first switch SW1 is connected to the input terminal of the power converter circuit 13 with the first resistor R1 interposed therebetween. The first switch SW1 may include one or more switching elements, e.g., an n-channel MOSFET.

The second switch SW2 is located between the power converter circuit 13 and the high-potential output terminal 12A for the load 40 on the high-potential power line LA. More specifically, a first end of the second switch SW2 is connected to the output terminal of the power converter circuit 13 with the second resistor R2 interposed therebetween. A second end of the second switch SW2 is connected to the high-potential output terminal 12A. The second switch SW2 may include one or more switching elements, e.g., an n-channel MOSFET.

The power supply 10 includes a voltage detector 14 and a current detector 15. The voltage detector 14 is configured to detect a voltage that is output from the power converter circuit 13. More specifically, a first end of the voltage detector 14 is connected to the output terminal of the power converter circuit 13. A second end of the voltage detector 14 is connected to the low-potential power line LB. Thus, the voltage detector 14 is configured to detect as a detected voltage Vd a potential difference between the potential of the high-potential power line LA, which is converted by the power converter circuit 13, and the ground potential of the low-potential power line LB.

The current detector 15 is configured to detect a current flowing between the power converter circuit 13 and the high-potential output terminal 12A. More specifically, the current detector 15 is configured to detect a current flowing through the second resistor R2 as a detected current id. A first end of the current detector 15 is connected to the first end of the second resistor R2. A second end of the current detector 15 is connected to the second end of the second resistor R2. The current detector 15 is configured to detect a current flowing from the battery 11 side to the load 40 side as a positive value and detect a current flowing from the load 40 side to the battery 11 side as a negative value.

### Controller of Power Supply Circuit and Program

As illustrated in FIG. 1, the power supply 10 includes the controller 20. The controller 20 is configured to acquire the detected voltage Vd detected by the voltage detector 14. The controller 20 is configured to acquire the detected current id detected by the current detector 15. The controller 20 can simultaneously acquire the detected voltage Vd and the detected current id. In addition, the controller 20 is configured to output a first control signal S1 for turning the first switch SW1 on or off. The controller 20 is configured to output a second control signal S2 for turning the second switch SW2 on or off. The controller 20 can also control turning on or off switching elements included in the power converter circuit 13.

The controller 20 includes a memory and a processor. That is, the controller 20 is a control circuit that may be a microcontroller unit (MCU). The memory is configured to store various programs to be executed by the processor and may be a non-transitory computer readable storage device. One of the programs is an abnormality detection program PG for detecting an abnormality in the detected voltage Vd and the detected current id. The processor includes, for example, a central processing unit (CPU) or a micro processing unit (MPU). In the following description, the execution of the abnormality detection program PG and various controls by the processor will simply be referred to as the execution and control by the controller 20. The processor is capable of executing the abnormality detection program PG. The abnormality detection program PG causes the controller 20 to execute a first control, a second control, and a third control. The controller 20 is configured to execute a threshold control using the detected voltage Vd, the detected current id, and predetermined thresholds in the first control, the second control, and the third control. The controller 20 is configured to execute the first control to the third control simultaneously. In other words, the controller 20 is configured to make a determination in each control simultaneously.

### First Control of Abnormality Detection Program

While the power converter circuit 13 is operating, the controller 20 executes the first control of the abnormality detection program PG. In the first control, the controller 20 executes a threshold control using a predetermined first voltage threshold and a predetermined first current threshold. While no abnormality is detected in any of the first, second, and third controls, the first switch SW1 and the second switch SW2 are both on.

When executing the first control, the controller 20 first determines whether the power converter circuit 13 is being controlled in the discharging state or in the charging state. The controller 20 sets the magnitude of the first current threshold to a larger value when the power converter circuit 13 is controlled in the charging state than when the power converter circuit 13 is controlled in the discharging state. For example, when the value of the first current threshold is −5 A in the discharging state, the controller 20 sets the first current threshold to −20 A in the charging state. For example, the memory of the controller 20 is configured to store in advance the first voltage threshold and the first current threshold in the charging state and the first voltage threshold and the first current threshold in the discharging state.

The controller 20 next acquires the detected voltage Vd and the detected current id simultaneously. The controller 20 then determines whether the magnitude of the detected voltage Vd is equal to or smaller than the magnitude of the predetermined first voltage threshold. The controller 20 also determines whether the magnitude of the detected current id is equal to or larger than the magnitude of the predetermined first current threshold. If one or more of the above two conditions are not met, the controller 20 repeatedly acquires the detected voltage Vd and the detected current id. When both of the above two conditions are met, the controller 20 determines that an abnormality has occurred. The controller 20 then turns off the first switch SW1 and the second switch SW2.

Note that the “magnitude of the detected current id” refers to the absolute value of the detected current id. Note that the “magnitude of a current threshold” refers to the absolute value of a current threshold. However, when determining whether the magnitude of the detected current id is equal to or larger than the magnitude of the first current threshold, it is not necessary to actually use or calculate the absolute value of the detected current id. In other words, when the detected current id has a positive value, the controller 20 may determine whether the detected current id is equal to or larger than a current threshold having a positive value. When the detected current id has a negative value, the controller 20 may determine whether the detected current id is equal to or smaller than a current threshold having a negative value. For example, if the detected current id is −5 A and the first current threshold is −4 A, the controller 20 determines that the magnitude of the detected current id is equal to or larger than the magnitude of the first current threshold. The same applies to the magnitudes of the detected voltage Vd and a voltage threshold. That is, when the detected voltage Vd has a positive value, the controller 20 may determine whether the detected voltage Vd is equal to or smaller than a voltage threshold having a positive value. When the detected voltage Vd has a negative value, the controller 20 may determine whether the detected voltage Vd is equal to or larger than a voltage threshold having a negative value.

### Second Control of Abnormality Detection Program

While the power converter circuit 13 is operating, the controller 20 executes the second control of the abnormality detection program PG. In the second control, the controller 20 executes a threshold control using a predetermined second voltage threshold and a predetermined second current threshold. Upon beginning the second control, the controller 20 first determines whether the power converter circuit 13 is being controlled in the discharging state or in the charging state. The controller 20 sets the magnitude of the second current threshold to a larger value when the power converter circuit 13 is controlled in the charging state than when the power converter circuit 13 is controlled in the discharging state. For example, the memory of the controller 20 is configured to store in advance the second voltage threshold and the second current threshold in the charging state and the second voltage threshold and the second current threshold in the discharging state. The second current threshold in the charging state is smaller than the first current threshold in the charging state, and the second current threshold in the discharging state is smaller than the first current threshold in the discharging state.

The controller 20 next acquires the detected voltage Vd and the detected current id simultaneously. The controller 20 then determines whether the magnitude of the detected voltage Vd is equal to or smaller than the magnitude of the second voltage threshold. The controller 20 also determines whether the magnitude of the detected current id is equal to or larger than the magnitude of the second current threshold. The second voltage threshold is larger than the first voltage threshold in the first control. As mentioned above, the second current threshold is smaller than the first current threshold in the first control. The controller 20 then determines whether a state in which one or more of the above two conditions are met has persisted for a first predetermined period. The first predetermined period is, for example, 37.5 μsec if the controller 20 is capable of acquiring the detected voltage Vd and the detected current id approximately every 12.5 μsec. That is, when the controller 20 observes a state in which a combination of the detected voltage Vd and the detected current id that have simultaneously been acquired meets one or more of the two conditions three times in a row, the controller 20 makes a determination that the state has persisted for the first predetermined period or longer. When this determination is affirmative, the controller 20 determines that an abnormality has occurred. The controller 20 then turns off the first switch SW1 and the second switch SW2.

Specifically, the magnitude of the detected voltage Vd is assumed to become equal to or smaller than the magnitude of the second voltage threshold while the magnitude of the detected current id is smaller than the magnitude of the second current threshold. That is, one of the two conditions above is met at this point. Upon determining that a state in which the magnitude of the detected voltage Vd is equal to or smaller than the magnitude of the second voltage threshold persists for the first predetermined period or longer, the controller 20 turns off the first switch SW1 and the second switch SW2.

In addition, the magnitude of the detected current id is assumed to become equal to or larger than the magnitude of the second current threshold while the magnitude of the detected voltage Vd is larger than the magnitude of the second voltage threshold. That is, one of the two conditions above is met at this point. Upon determining that a state in which the magnitude of the detected current id is equal to or larger than the magnitude of the second current threshold persists for the first predetermined period or longer, the controller 20 turns off the first switch SW1 and the second switch SW2.

In another case, the magnitude of the detected current id is assumed to become equal to or larger than the magnitude of the second current threshold while the magnitude of the detected voltage Vd is larger than the magnitude of the second voltage threshold. However, a state in which the magnitude of the detected current id is equal to or larger than the magnitude of the second current threshold is assumed to persist only momentarily, and the time during which this condition is met is assumed to be shorter than the first predetermined period. In this case, the controller 20 keeps the first switch SW1 and the second switch SW2 on.

### Third Control of Abnormality Detection Program

While the power converter circuit 13 is operating, the controller 20 executes the third control of the abnormality detection program PG. In the third control, the controller 20 executes a threshold control using the predetermined second voltage threshold and the predetermined second current threshold. Upon beginning the third control, the controller 20 first determines whether the power converter circuit 13 is being controlled in the discharging state or in the charging state. The controller 20 sets the magnitude of the second current threshold to a larger value when the power converter circuit 13 is controlled in the charging state than when the power converter circuit 13 is controlled in the discharging state.

The controller 20 next acquires the detected voltage Vd and the detected current id simultaneously. The controller 20 then determines whether the magnitude of the detected voltage Vd is equal to or smaller than the magnitude of the second voltage threshold. The controller 20 also determines whether the magnitude of the detected current id is equal to or larger than the magnitude of the second current threshold. The second voltage threshold is equal to the second voltage threshold in the second control. The second current threshold is equal to the second current threshold in the second control. The controller 20 then determines whether a state in which the above two conditions are both met has persisted for a second predetermined period. The second predetermined period is, for example, 25 μsec if the controller 20 is capable of acquiring the detected voltage Vd and the detected current id approximately every 12.5 μsec. That is, when the controller 20 observes a state in which a combination of the detected voltage Vd and the detected current id that have simultaneously been acquired meets both of the two conditions two times in a row, the controller 20 makes a determination that the state has persisted for the second predetermined period or longer. When this determination is affirmative, the controller 20 determines that an abnormality has occurred. The controller 20 then turns off the first switch SW1 and the second switch SW2.

### Operation of Present Embodiment

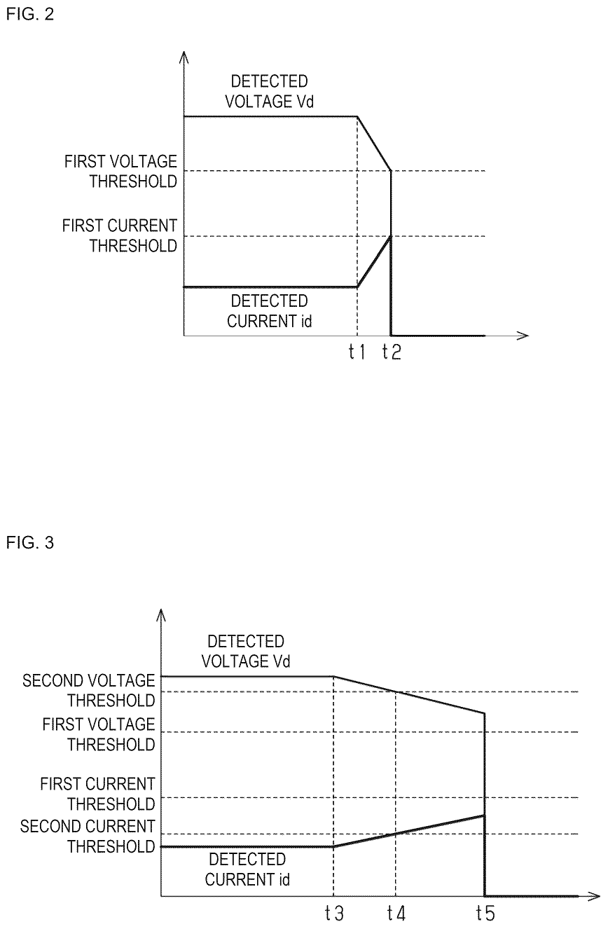

As illustrated in FIG. 2, the output terminal of the power converter circuit 13 is assumed to be short-circuited to the low-potential power line LB at time t1. At this time, the detected voltage Vd decreases. Further, current flows toward the short-circuited point from a component such as a capacitor in the load 40 connected to the high-potential output terminal 12A and a power source connected to the high-potential output terminal 12A. As a result, the magnitude of the detected current id increases. The magnitude of the detected voltage Vd is assumed to become equal to or smaller than the magnitude of the first voltage threshold, and the magnitude of the detected current id becomes equal to or larger than the magnitude of the first current threshold at time t2. In this case, the controller 20 turns off the first switch SW1 and the second switch SW2.

If a short circuit is detected based on only one of the detected voltage Vd and the detected current id, a momentary voltage fluctuation such as noise may cause the value of the detected voltage Vd to momentarily become equal to or smaller than the magnitude of the first voltage threshold. Thus, the controller 20 may erroneously determine that a short circuit has occurred based on a momentary fluctuation in the detected voltage Vd. In contrast, for example, if a short circuit is detected in response to repeated detection of the magnitude of the detected voltage Vd being equal to or smaller than the magnitude of the first voltage threshold after time t2, the possibility of erroneous determination as described above can be reduced. However, this type of detection method requires a long time to detect a short circuit after the short circuit has occurred. That is, an adverse effect of the short circuit may last long.

In contrast, the possibility of erroneous detection can be reduced in the first control of the present embodiment since the detection is made based on not only the detected voltage Vd but also the detected current id. Further, the possibility of the adverse effect of a short circuit lasting long can be reduced since the detection process does not take long.

As illustrated in FIG. 3, a short circuit is assumed to occur in the second capacitor C2 at time t3. In this case, the more gradually the detected voltage Vd and the detected current id change, the longer it takes for the magnitude of the detected voltage Vd to reach the first voltage threshold and for the magnitude of the detected current id to reach the first current threshold. In the second control of the present embodiment, the second voltage threshold is set to a value larger than the first voltage threshold. The second current threshold is set to a value smaller than the first current threshold. With time t4 referring to the time that the magnitude of the detected voltage Vd becomes equal to or smaller than the magnitude of the second voltage threshold, the controller 20 turns off the first switch SW1 and the second switch SW2 if the magnitude of the detected voltage Vd remains equal to or smaller than the magnitude of the second voltage threshold during the period from time t4 to time t5, which is the first predetermined period after time t4. Since a similar procedure is applied to the detected current id, the possibility that the controller 20 erroneously detects a short circuit can be reduced.

In the third control, each switch is turned off when the magnitude of the detected voltage Vd remains equal to or smaller than the magnitude of the second voltage threshold and the magnitude of the detected current id remains equal to or larger than the magnitude of the second current threshold for the second predetermined period. The third control further reduces the possibility of erroneous detection compared with the second control. Thus, the second predetermined period is shorter than the first predetermined period.

### Effect of Present Embodiment

(1) In the above embodiment, the controller 20 turns off the first switch SW1 and the second switch SW2 when the magnitude of the detected voltage Vd is equal to or smaller than the magnitude of the first voltage threshold and the magnitude of the detected current id is equal to or larger than the magnitude of the first current threshold. As described above, this configuration reduces the possibility of erroneous detection of a short circuit compared with a configuration in which detection is made based on either a voltage value or a current value. In addition, since a short circuit can be detected in a single determination instead of multiple determinations, the occurrence of a short circuit can be detected promptly. That is, the above embodiment can reduce the possibility of erroneous detection while maintaining promptness of the determination.

(2) In the above embodiment, the controller 20 sets the magnitude of the first current threshold to a larger value in a charging state in which power is supplied from a pair of output terminals to the battery 11 than in a discharging state in which power is supplied from the battery 11 to the pair of output terminals. In the charging state, current flows from the high-potential output terminal 12A side to the power converter circuit 13 side. If a short circuit occurs in this state, short-circuit current is likely to be larger than in the discharging state. Considering this, setting the first current threshold to a larger value in the discharging state can enhance the accuracy of determining that an abnormality has occurred in the discharging state.

(3) In the above embodiment, the controller 20 turns off the first switch SW1 and the second switch SW2 when one or more of first and second conditions persist for a first predetermined period, the first condition being that the magnitude of the detected voltage Vd is equal to or smaller than the magnitude of the second voltage threshold, the second condition being that the magnitude of the detected current id is equal to or larger than the magnitude of the second current threshold. After a short circuit occurs, the detected voltage Vd and the detected current id may change gradually. In such a case, the controller 20 can detect a short circuit relatively promptly while reducing the possibility of erroneous detection by detecting the conditions related to the detected values using a logical sum (OR).

(4) In the above embodiment, the controller 20 turns off the first switch SW1 and the second switch SW2 when a first condition and a second condition both persist for a second predetermined period, the first condition being that the magnitude of the detected voltage Vd is equal to or smaller than the magnitude of the second voltage threshold, the second condition being that the magnitude of the detected current id is equal to or larger than the magnitude of the second current threshold. When the detected voltage Vd and the detected current id change gradually after a short circuit occurs, the controller 20 can more easily reduce the possibility of erroneous detection by detecting the conditions related to the detected values using a logical product (AND).

### Modifications

The above embodiment can be implemented with the following modifications. The above embodiment and the following modifications can be implemented in combination with each other to the extent that no technical contradiction occurs.
The power supply 10 may include multiple batteries 11. In this case, the abnormality detection program PG may be applied to the multiple batteries 11 as a single direct-current power supply, or the abnormality detection program PG may be applied separately to each of the multiple batteries 11.
The load 40 is not limited to the server or other devices illustrated in the above embodiment. Furthermore, the power source to be connected to the output terminals may be connected with an inverter or other devices interposed therebetween.
The power supply 10 may also include other components, such as a fuse.
The power converter circuit 13 is not limited to the example in the above embodiment. For example, the power converter circuit 13, which is a bidirectional converter, may be replaced with two converters: a boost converter configured to step up the voltage from the battery 11 and a boost converter configured to step up the voltage supplied from the power source connected to the output terminals.
The power supply 10 may include only the first switch SW1 or may include only the second switch SW2. The power supply 10 may at least include a switch that is located on the high-potential power line LA and that can be turned on or off.
The configuration of each switch is not limited to the example in the above embodiment. Each switch may be turned on or off by a control signal from the controller 20. For example, each switch may include multiple switching elements connected in series or in parallel. The switching elements are not limited to N-type MOSFETs and may be P-type MOSFETs or other transistors.
The power supply 10 may include multiple controllers 20. For example, a controller 20 may be provided for each switch.
The values of the first voltage threshold and the first current threshold need not be stored in the memory of the controller 20 in advance. Those values may be set to any values after the power supply 10 begins operation.
The controller 20 may turn off any one of the switches at least when the magnitude of the detected voltage Vd is equal to or smaller than the magnitude of the first voltage threshold and the detected current id is equal to or larger than the magnitude of the first current threshold. Thus, in the first control, the controller 20 may execute the above control only in the discharging state or may execute the above control only in the charging state. The controller 20 need not set the magnitude of the first current threshold to a larger value in the charging state than in the discharging state. In other words, the magnitude of the first current threshold in the charging state may be equal to or smaller than the magnitude of the first current threshold in the discharging state. The controller 20 may set the magnitude of the first voltage threshold to a smaller value in the charging state than in the discharging state.

### Appendix

The technical scope that can be understood from the above embodiment and the modifications will be described.

[1] A power supply comprising: a pair of output terminals; a power line connected to the output terminals; a battery capable of outputting power from the output terminals via the power line; a switch located on the power line; a power converter circuit located on the power line and capable of converting an input voltage and outputting a converted voltage; a voltage detector configured to detect a voltage that is output from the power converter circuit; a current detector configured to detect a current between the power converter circuit and the output terminals; and a controller capable of turning the switch on or off, wherein the controller turns the switch off when a magnitude of the voltage detected by the voltage detector is equal to or smaller than a magnitude of a predetermined voltage threshold and a magnitude of the current detected by the current detector is equal to or larger than a magnitude of a predetermined current threshold.

[2] The power supply according to [1], wherein the controller is configured to set the magnitude of the current threshold to a larger value in a charging state in which power is supplied from the output terminals to the battery than in a discharging state in which power is supplied from the battery to the output terminals.

[3] The power supply according to [1] or [2], wherein the voltage threshold is defined as a first voltage threshold, the current threshold is defined as a first current threshold, a threshold larger than the first voltage threshold is defined as a second voltage threshold, and a threshold smaller than the first current threshold is defined as a second current threshold, and wherein the controller turns the switch off when one or more of first and second conditions persist for a predetermined period, the first condition being that the magnitude of the voltage detected by the voltage detector is equal to or smaller than a magnitude of the second voltage threshold, the second condition being that the magnitude of the current detected by the current detector is equal to or larger than a magnitude of the second current threshold.

[4] The power supply according to any one of [1] to [3], wherein the voltage threshold is defined as a first voltage threshold, the current threshold is defined as a first current threshold, a threshold larger than the first voltage threshold is defined as a second voltage threshold, and a threshold smaller than the first current threshold is defined as a second current threshold, and wherein the controller turns the switch off when a first condition and a second condition both persist for a predetermined period, the first condition being that the magnitude of the voltage detected by the voltage detector is equal to or smaller than a magnitude of the second voltage threshold, the second condition being that the magnitude of the current detected by the current detector is equal to or larger than a magnitude of the second current threshold.

[5] A program to be applied to a power supply, the power supply comprising: a pair of output terminals; a power line connected to the output terminals; a battery capable of outputting power from the output terminals via the power line; a switch located on the power line; a power converter circuit located on the power line and capable of converting an input voltage and outputting a converted voltage; a voltage detector configured to detect a voltage that is output from the power converter circuit; a current detector configured to detect a current between the power converter circuit and the output terminals; and a controller capable of turning the switch on or off, the program comprising instructions for causing the controller to turn the switch off when a magnitude of the voltage detected by the voltage detector is equal to or smaller than a magnitude of a predetermined voltage threshold and a magnitude of the current detected by the current detector is equal to or larger than a magnitude of a predetermined current threshold.

What is claimed is:

1. A power supply comprising:
a pair of output terminals;
a power line connected to the output terminals;
a battery configured to output power from the output terminals via the power line;
a switch located on the power line;
a power converter circuit located on the power line and capable of converting an input voltage and outputting a converted voltage;
a voltage detector configured to detect a voltage that is output from the power converter circuit;
a current detector configured to detect a current between the power converter circuit and the output terminals; and
a control circuit configured to control a state of the switch,
wherein the control circuit is configured to turn the switch off when a magnitude of the voltage detected by the voltage detector is equal to or smaller than a magnitude of a predetermined voltage threshold and a magnitude of the current detected by the current detector is equal to or larger than a magnitude of a predetermined current threshold.

2. The power supply according to claim 1,
wherein the control circuit is configured to set the magnitude of the current threshold to a larger value in a charging state in which power is supplied from the output terminals to the battery than in a discharging state in which power is supplied from the battery to the output terminals.

3. The power supply according to claim 1,
wherein the voltage threshold is defined as a first voltage threshold,
the current threshold is defined as a first current threshold,
a threshold larger than the first voltage threshold is defined as a second voltage threshold, and
a threshold smaller than the first current threshold is defined as a second current threshold, and
wherein the control circuit is configured to turn the switch off when one or more of first and second conditions persist for a predetermined period, the first condition being that the magnitude of the voltage detected by the voltage detector is equal to or smaller than a magnitude of the second voltage threshold, the second condition being that the magnitude of the current detected by the current detector is equal to or larger than a magnitude of the second current threshold.

4. The power supply according to claim 1,
wherein the voltage threshold is defined as a first voltage threshold,
the current threshold is defined as a first current threshold,
a threshold larger than the first voltage threshold is defined as a second voltage threshold, and
a threshold smaller than the first current threshold is defined as a second current threshold, and
wherein the control circuit is configured to turn the switch off when a first condition and a second condition both persist for a predetermined period, the first condition being that the magnitude of the voltage detected by the voltage detector is equal to or smaller than a magnitude of the second voltage threshold, the second condition being that the magnitude of the current detected by the current detector is equal to or larger than a magnitude of the second current threshold.

5. The power supply according to claim 1,
wherein the switch is between the battery and the power converter circuit.

6. The power supply according to claim 1, wherein the switch is between the power converter circuit and one output terminal of the pair of output terminals.

7. The power supply according to claim 1,
wherein the switch is a first switch between the battery and the power converter circuit, and the power supply further includes a second switch between the power converter circuit and one output terminal of the pair of output terminals.

8. The power supply according to claim 7,
wherein the control circuit is configured to control states of both the first switch and the second switch.

9. A non-transitory computer readable storage device having computer readable instructions that when executed by circuitry cause the circuitry to control a power supply,
the power supply including:
a pair of output terminals;
a power line connected to the output terminals;
a battery capable of outputting power from the output terminals via the power line;
a switch located on the power line;
a power converter circuit located on the power line and capable of converting an input voltage and outputting a converted voltage;
a voltage detector configured to detect a voltage that is output from the power converter circuit; and
a current detector configured to detect a current between the power converter circuit and the output terminals;
wherein the circuitry is caused to control a state of the switch,
by turning the switch off when a magnitude of the voltage detected by the voltage detector is equal to or smaller than a magnitude of a predetermined voltage threshold and a magnitude of the current detected by the current detector is equal to or larger than a magnitude of a predetermined current threshold.

10. The non-transitory computer readable storage device according to claim 9,
wherein the circuitry is caused to set the magnitude of the current threshold to a larger value in a charging state in which power is supplied from the output terminals to the battery than in a discharging state in which power is supplied from the battery to the output terminals.

11. The non-transitory computer readable storage device according to claim 9,
wherein the voltage threshold is defined as a first voltage threshold,
the current threshold is defined as a first current threshold,
a threshold larger than the first voltage threshold is defined as a second voltage threshold, and
a threshold smaller than the first current threshold is defined as a second current threshold, and
wherein the circuitry is caused to turn the switch off when one or more of first and second conditions persist for a predetermined period, the first condition being that the magnitude of the voltage detected by the voltage detector is equal to or smaller than a magnitude of the second voltage threshold, the second condition being that the magnitude of the current detected by the current detector is equal to or larger than a magnitude of the second current threshold.

12. The non-transitory computer readable storage device according to claim 9,
wherein the voltage threshold is defined as a first voltage threshold,
the current threshold is defined as a first current threshold,
a threshold larger than the first voltage threshold is defined as a second voltage threshold, and
a threshold smaller than the first current threshold is defined as a second current threshold, and
wherein the circuitry is configured to turn the switch off when a first condition and a second condition both persist for a predetermined period, the first condition being that the magnitude of the voltage detected by the voltage detector is equal to or smaller than a magnitude of the second voltage threshold, the second condition being that the magnitude of the current detected by the current detector is equal to or larger than a magnitude of the second current threshold.

13. A control circuit for use with a power supply, the power supply including:
a pair of output terminals;
a power line connected to the output terminals;
a battery configured to output power from the output terminals via the power line;
a switch located on the power line;
a power converter circuit located on the power line and capable of converting an input voltage and outputting a converted voltage;
a voltage detector configured to detect a voltage that is output from the power converter circuit; and
a current detector configured to detect a current between the power converter circuit and the output terminals,
wherein the control circuit is configured to turn the switch off when a magnitude of the voltage detected by the voltage detector is equal to or smaller than a magnitude of a predetermined voltage threshold and a magnitude of the current detected by the current detector is equal to or larger than a magnitude of a predetermined current threshold.

14. The control circuit according to claim 13,
wherein the control circuit is configured to set the magnitude of the current threshold to a larger value in a charging state in which power is supplied from the output terminals to the battery than in a discharging state in which power is supplied from the battery to the output terminals.

15. The control circuit according to claim 13,
wherein the voltage threshold is defined as a first voltage threshold,
the current threshold is defined as a first current threshold,
a threshold larger than the first voltage threshold is defined as a second voltage threshold, and
a threshold smaller than the first current threshold is defined as a second current threshold, and
wherein the control circuit is configured to turn the switch off when one or more of first and second conditions persist for a predetermined period, the first condition being that the magnitude of the voltage detected by the voltage detector is equal to or smaller than a magnitude of the second voltage threshold, the second condition being that the magnitude of the current detected by the current detector is equal to or larger than a magnitude of the second current threshold.

16. The control circuit according to claim 13,
wherein the voltage threshold is defined as a first voltage threshold,
the current threshold is defined as a first current threshold,
a threshold larger than the first voltage threshold is defined as a second voltage threshold, and
a threshold smaller than the first current threshold is defined as a second current threshold, and
wherein the control circuit is configured to turn the switch off when a first condition and a second condition both persist for a predetermined period, the first condition being that the magnitude of the voltage detected by the voltage detector is equal to or smaller than a magnitude of the second voltage threshold, the second condition being that the magnitude of the current detected by the current detector is equal to or larger than a magnitude of the second current threshold.
